(19) United States
(12) Patent Application Publication
(10) Pub. No.: US 2007/0039542 A1
(43) Pub. Date: Feb. 22, 2007

(54) Flag butler

(76) Inventors: Amanda Schrauwen, Longwood, FL (US); Nicholas Yntze Schrauwen, Longwood, FL (US)

Correspondence Address: Amanda Schrauwen, 341 Brantley Club Place, Longwood, FL, 32779, US

(21) Appl. No.: 11/374,293

(22) Filed: Dec. 27, 2005

(51) Int. Cl. G09F 9/00

(52) U.S. Cl. 116/313

(57) ABSTRACT

The “Flag Butler” signal/flag improves the communication between waiters/servers or attendants and the customers. The waiters/servers or attendants will not have to continually ask if each person needs assistance, which takes up time and sometimes becomes a nuisance to the customers. The waiters/servers or attendants can spend more time getting orders done efficiently. The signal/flag is easily visible in contrasting colors to its environment.

A signal/flag called “Flag Butler” attached to a beach chair, pool lounger, bar stool/chair, golf cart, cabana or necessary object that shows the hotel, resort, outside bar, restaurant service, any establishment or staff/person you need indicate, that you need service

### DESCRIPTION

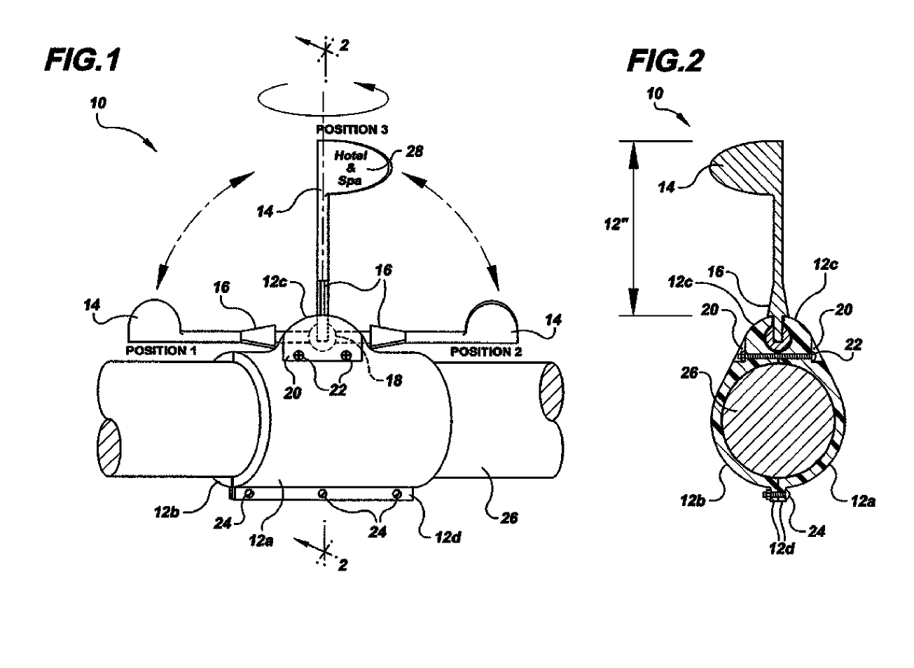

The signal/flag itself (14) would be ideally molded in the desired material with a design/signature/logo (28) on the flag section to any client's specifications and could be made of one material such as plastic, as a whole, or it could have a traditional flag attached made of fabric material that has different color's either printed with a design/signature/logo or not. A standard signal could be a 2″ diameter ball joint (18) connected to a 12″ pole ⅜″ diameter (14) with a locking mechanism (16) with a flat round-ended flag approx. 3″, ½ disc shape top end, all made out of plastic. The ball joint moves around in it's housing 360 degrees as seen in FIG. 1. The housing consists of 2 identical sections (12 a & 12b) that would be made of the materials of choice, example plastic or wood. It could be attached with screws (22 & 24) to any shaped rail (26) as shown, a circular rail/pole is used as example but easily moulded for any shape and size.

One of the things that make this invention unique is the signal/flag ball joint. It rotates the signal/flag 360 degrees allowing the signal/flag to be placed in any position required, thus attracting attention. Another unique invention to the signal/flag is the locking action (16) on the base of the pole. It uses the ball joint swivel to lock in the ridges thus making it stationery in an upright position.

A signal/flag attached to any object such as a beach chair, pool lounger, bar chair, golf cart, cabana etc., that tells the hotel, resort outside bar, restaurant service, establishment, staff or person that you need service. The signal is raised by lifting the flag (14), positioning it by using the ball joint (18) and swiveling the flag up. The signal/flag is then put in position using the ridge or locking devise (16) which keeps the flag stationery on it's housing. Notifying the attendant for service, once the attendant has seen the raised signal/flag they can take the order and put the signal/flag in the down position.

It can be primarily used in either a Hotel pool deck, beach, restaurant, Casino—who may choose to use it on the side/top of a slot machine, a Golf course may use them on golf carts and Resorts may use them on pool loungers, beach chairs or on cabanas. The signaling flag devise can be used in any number of establishments where service is required. It could just be used to attract attention, It has a number of possibilities.

Depending on the client, the signal/flag could be molded to reflect their own signature, for example: Disney may want a Mickey Mouse-shaped flag section, a golf course may want a golf club or golf ball for the flag section and a Resort may simply have their logo or symbol printed on the flag section. Made out of plastic or fabric the flag sections can be molded to reflect a client in shape and color, printing on it is optional. The signal/flag could be made of any number of materials, such as wood or plastic. Another unique invention to the signal/flag is an alternative to the ridges for a locking mechanism, it would be possible to use traction on the ball joint by adding a rougher outer surface to the ball joint, thus enabling the ball joint to stay in place in an upward fashion, eliminating the need for ridges. This method would make the ball joint harder to move, but is an option. It is possible with the plastic housing to forego the screws, replacing the 2 housing sections with one continual housing for the ball joint, encompassing the rail (26) ¾ around, clipping onto the rail using it's own elasticity. Alternatively, you could simplify the housing to directly screw onto the rail (26) without encompassing the rail, it will simply house the ball joint enabling it to move. We have shown in FIG. 1 and 2 diagrams that do not screw into the object/rail (26). Another example would be a pole that moved vertically up and down either by spring action with a locking device or pulley system. Still attached to an object/rail for service or attention. The signal/flag could be structured another way, without a ball joint.

What is claimed is:

1. A signal/flag attached to any object such as a beach chair, pool lounger, bar chair, golf cart, cabana etc., that tells the hotel, resort outside bar, restaurant service, establishment, staff or person that you need service. The signal is raised for service, once the server has seen the raised signal/flag they can take the order and put the signal/flag in the down position.
